(19) United States
(12) Patent Application Publication
(10) Pub. No.: US 2025/0323034 A1
(43) Pub. Date: Oct. 16, 2025

(54) IRRADIATION DEVICE WITH EXCIMER EMITTERS AS UV SOURCE

(71) Applicant: IOT – INNOVATIVE OBERFLAECHENTECHNOLOGIEN GMBH, LEIPZIG (DE)

(72) Inventors: REINER MEHNERT, HAINICHEN OT BOCKENDORF (DE); THOMAS RIEDEL, MARKKLEEBERG (DE); FRANK RUDZIK, LEIPZIG (DE)

(73) Assignee: IOT – INNOVATIVE OBERFLAECHENTECHNOLOGIEN GMBH, LEIPZIG (DE)

(21) Appl. No.: 18/866,078

(22) PCT Filed: May 19, 2022
(86) PCT No.: PCT/EP2022/025235

§ 371 Date: Nov. 15, 2024

(51) Int. Cl. H01J 61/52; C09D 11/101; C09D 11/107; C09D 133/04; C09J 133/04; H01J 61/02; H01J 61/04

(52) U.S. Cl. CPC H01J 61/526; C09D 11/101; C09D 11/107; C09D 133/04; C09J 133/04; H01J 61/025; H01J 61/04

(57) ABSTRACT

An irradiation device includes a housing, reflectors arranged on sides of the housing, an excimer emitter as a UV radiation source, porous sintered metal distributor elements, a chamber acting as a buffer volume, a high-voltage socket, an earth connection, and an emitter head having holes. The excimer emitter has an inner electrode and an outer electrode. The distributor elements are arranged along the excimer emitter. The emitter head is provided as a molded body to accommodate the inner electrode and the outer electrode. The emitter head form-fittingly guides the inner electrode and the outer electrode to the high-voltage socket and/or to the earth connection, and provides a supply of deionized cooling water to an inner cooling channel and to an outer cooling channel via the holes to cool the excimer emitter. A nitrogen flushing takes place via the distributor elements and the chamber.

### CROSS REFERENCE TO PRIOR APPLICATIONS

This application is a U.S. National Phase application under 35 U.S.C. § 371 of International Application No. PCT/EP2022/025235, filed on May 19, 2022. The International Application was published in German on Nov. 23, 2023 as WO 2023/222178 A1 under PCT Article 21(2).

### FIELD

The present invention relates to a technically employable irradiation device with excimer emitters as a UV source.

### BACKGROUND

Noble gas halogen excimer emitters with emission wavelengths of, for example, 207, 222, 253, 282 and 308 nm can be used for the UV cross-linking of radiation-curing coatings, printing inks, and adhesives that contain acrylates as oligomers and monomers.

The prerequisite for efficient UV cross-linking is that these emitters achieve irradiance levels >50 mW/cm², that suitable photoinitiators are used to initiate UV cross-linking, and that irradiation takes place in an inert atmosphere with oxygen concentrations of <500 ppm.

The degree and speed of cross-linking then correspond to the values achieved by irradiation with medium-pressure mercury lamps.

Photons with wavelengths of 207 or 222 nm are absorbed in acrylates directly under the excitation of electrons of the acrylate double bond.

The penetration depth of the photons is here specified as 1.5 or 2.5 μm, respectively.

As a result of the resulting high concentration of radicals in a layer close to the surface, a high degree of cross-linking is achieved on the surface.

By selecting suitable photoinitiators, however, the effect of the preferential surface cross-linking can also be produced for all other noble gas halogen excimer emitters mentioned above.

The basic geometric shape of both lamp types, namely mercury medium-pressure emitters or excimer emitters, is a quartz tube cylinder with an outer diameter of between 9 and 40 mm and lengths of up to several meters. The electrically excited discharge, which generates the UV radiation required for the chemical cross-linking process, takes place in the sealed cylinder.

An excimer emitter is described in EP 0 254 111 B1 and in B. Eliasson, U. Kogelschatz: Appl. Phys. B 46, p. 299 (1988).

In a dielectric barrier discharge, which is generated in the noble gas-halogen mixture by applying a sinusoidal alternating voltage with typical frequencies of 10 kHz to 1 MHz and amplitudes of up to 20,000 V or corresponding high-frequency high-voltage pulses, excited noble gas atoms and ions are formed by electron impact, which recombine via short-lived noble gas cations and halogen anions to form excited noble gas-halogen excimers such as KrBr* (207 nm), KrCl* (222 nm), XeJ*(253 nm), XeBr*(282 nm) or XeCl* (308 nm). The lifetime of the excited excimers is a few 100 nanoseconds. During decay, the excited noble gas-halogen excimers emit their excitation energy as radiation and then decay into their atoms in the ground state. The emission wavelengths for some technically usable excimers are given in parentheses in the text above.

A typical embodiment of an excimer emitter is described in DE 41 40 497 C2. An inner tube is there arranged coaxially in an outer quartz tube with an outer diameter of 30 to 40 mm and a wall thickness of 0.5-1.5 mm. The outer and inner tubes are joined and fused together at their ends. This creates a closed cylindrical cavity as a discharge chamber, which is filled with a suitable noble gas-halogen mixture.

This discharge space is located between an inner and an outer electrode, which can be designed as a metal coil or mesh.

The electrodes are connected to the two poles of an alternating voltage or pulse generator. Adjustable voltage amplitudes of between 1,000 and 20,000 volts at frequencies of up to 1,000 kHz are required to form the discharge depending on the gas filling.

The advantage thereof is that the discharge space can be cooled from the outside with water. This does not impair the gas discharge in contrast to mercury medium-pressure emitters.

Due to the high voltage applied, deionized water is used for cooling and is circulated through the channel of the inner electrode via the outer electrode. The outer electrode is surrounded by a cylindrical cladding tube through which the cooling water flows.

The surface temperature of the cladding tube then corresponds to the cooling water temperature. Compared to mercury medium-pressure emitters, noble gas-halogen excimer emitters have the following advantages:
low heat input into the substrate due to water cooling of the inner and outer surface of the discharge tube;
high energy efficiency and long service life due to elimination of internal electrodes;
no warm-up time, i.e., switch-on and switch-off time in the millisecond range;
no mechanical shutter required to switch the radiation on and off; and
no use of mercury.

It is also known that inhibition of cross-linking by oxygen can be ruled out by flushing the irradiation chamber in which cross-linking takes place with nitrogen. A suitable device for flushing the irradiation zone with nitrogen is described in EP 2 786 807 B1. Nozzles equipped with perforated or porous distributor elements are there described.

### SUMMARY

An aspect of the present invention is to provide a device which can be used as a technically employable irradiation device with excimer emitters as a UV source, for example, for the cross-linking of acrylate-based radiation-curable printing inks, coatings, and adhesives.

In an embodiment, the present invention provides an irradiation device which includes a housing, reflectors arranged on sides of the housing, an excimer emitter as a UV radiation source, distributor elements comprising a porous sintered metal, a chamber which is configured to act as a buffer volume, a high-voltage socket, an earth connection, and an emitter head comprising holes. The excimer emitter comprises an inner electrode and an outer electrode. The distributor elements are arranged along the excimer emitter. The emitter head is provided as a molded body to accommodate the inner electrode and the outer electrode of the excimer emitter. The emitter head is configured to form-fittingly guide each of the inner electrode and the outer electrode of the excimer emitter to at least one of the high-voltage socket and to the earth connection, and to provide a supply of deionized cooling water to an inner cooling channel and to an outer cooling channel via the holes so as to cool the excimer emitter. A nitrogen flushing takes place via the distributor elements and the chamber.

### BRIEF DESCRIPTION OF THE DRAWINGS

The present invention is described in greater detail below on the basis of embodiments and of the drawings in which:

FIG. 1 shows a longitudinal section of the irradiation device according to the present invention; and

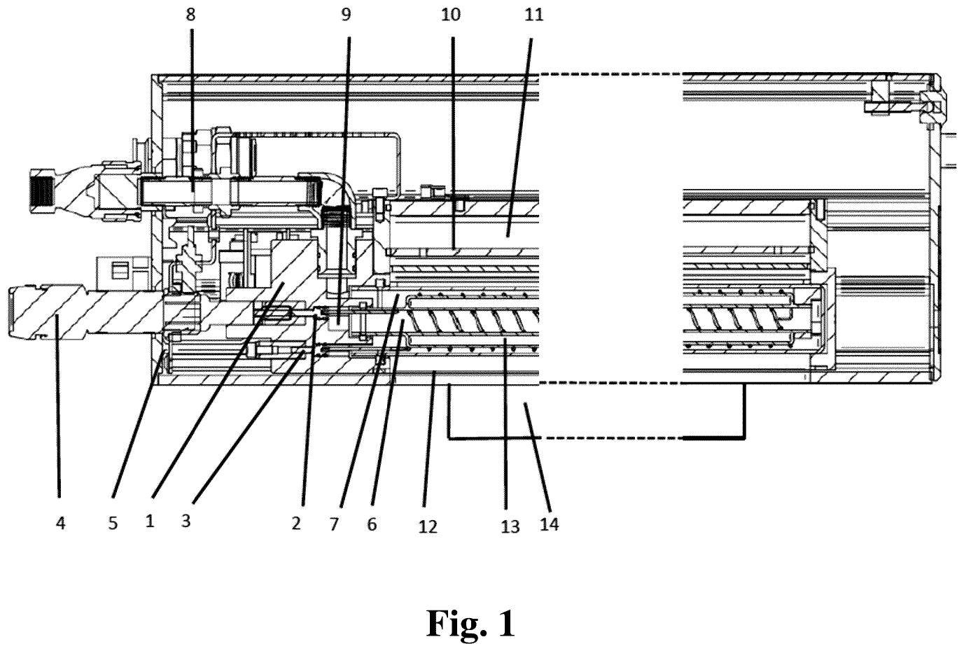

FIG. 2 shows a cross-section of the irradiation device according to the present invention.

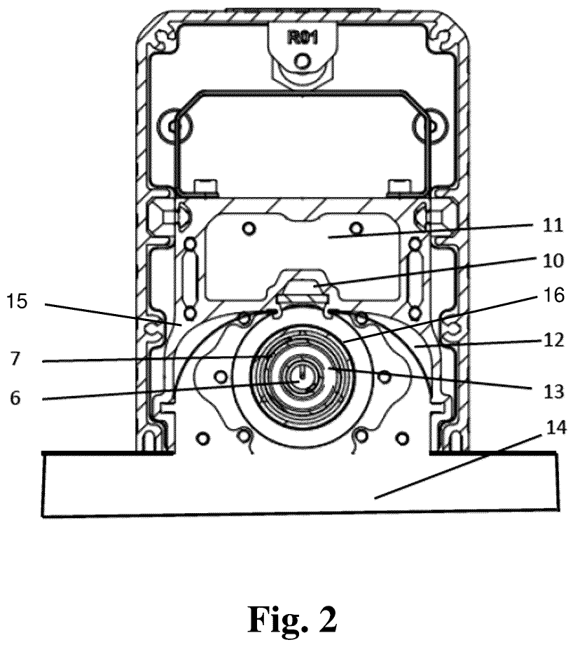

### DETAILED DESCRIPTION

The irradiation device according to the present invention is suitable for high voltages of up to 20,000 V. The irradiation device has a cooling circuit with deionized water at flow rates of 1 to 10 l/min and uses reflectors to generate a photon flux directed onto the irradiation plane and provides the inertization of the irradiation chamber 14 with nitrogen at flow rates of 1 to 100 Nm³/h.

The irradiation device according to the present invention will be explained in greater detail below with reference to an exemplary embodiment as shown in the drawings.

According to the present invention, the emitter head 1 is designed as a molded body which can, for example, be made of Teflon and accommodates a cylindrical inner electrode 2 and an outer electrode 3 of an cylindrical excimer emitter 13 and guides these to a high-voltage socket 4 or to the earth connection 5.

The receptacle for the inner electrode 2 in the high-voltage electrode in the emitter head 1 is designed to be form-fitting. This provides that no air exists between the inner electrode 2 and the emitter head 1 as a harmful dielectric for the high-voltage resistance. The high-voltage socket 4 for connecting the irradiation device to a high-voltage source is also inserted into the emitter head 1 via suction. The cylindrical excimer emitter 13 is designed as a hollow quartz cylinder so that cooling water can be fed therein from an inner cooling channel 6 into the outer cooling channel 7, which is formed by the outer casing of the excimer emitter 13 and a cylindrical quartz cladding tube 16. Holes are provided in the emitter head 1 for the inflow 8 and outflow 9 of the cooling water and lead to the inner cooling channel 6 and the outer cooling channel 7, respectively. As the inner electrode 2 located in the inner cooling channel 6 is at high-voltage potential in the operating state, deionized water with an electrical conductance <10 μS is used for cooling.

The cooling channels 6 and 7 are designed so that the pressure drop in the cooling area of the excimer emitter is <0.5 bar. This largely prevents mechanical stress on the hollow quartz body caused by pressure surges in the cooling water.

The irradiation device according to the present invention is to be used for the radiation cross-linking of coatings, printing inks, and adhesives. In order to exclude the inhibition of cross-linking by oxygen, the irradiation chamber 14, in which cross-linking takes place, is purged with nitrogen.

The irradiation device according to the present invention has distributor elements 10 made of porous sintered metal arranged directly above the excimer emitter 13. The nitrogen is fed into a chamber 11 which acts as a buffer volume.

From chamber 11, the nitrogen can flow out via the porous distributor elements 10 arranged along the excimer emitter 13. The outflowing nitrogen reaches flow velocities of 0.4 to 5 m/s with flows of 0.5 to 20 Nm³/h. The pressure in the chamber 11 is set so that the nitrogen flow is distributed as homogeneously as possible over the length of the excimer emitter 13 as it exits the sintered metal.

With a sufficiently dimensioned volume of the chamber 11 and a nitrogen inlet pressure of >2 bar, a homogeneity of the outflow velocity of <10% is achieved. The nitrogen flows around a substantial part of the surface of the excimer emitter 13 and simultaneously flushes the volume of the irradiation chamber 14. This reduces the oxygen concentration in the irradiation chamber 14 to <500 ppm.

Both the inertization of the irradiation chamber 14 and the protection of the surface of the excimer emitter 13 against contamination, for example, through the condensation of volatile organic components from paints, printing inks or adhesives, is thereby achieved.

The irradiation device according to the present invention is used for cross-linking radiation-curable layers that pass through the irradiation zone in the inertized irradiation chamber 14.

In order to increase the irradiance level in the layer to be cross-linked, reflectors 12 are mounted in the irradiation device so that part of the coaxially emitted excimer radiation is focused in the direction of the layer to be cross-linked.

Coated aluminum surfaces with a reflection of >90% in the UV range are used as reflectors 12. Two reflector surfaces are arranged on the sides of a housing 15 of the irradiation device so as to minimize reflection onto the surface of the excimer emitter 13. The cross-section of the reflector surfaces can, for example, be parabolic and results in a beam distribution that increases the irradiance level in the irradiation plane by 30%.

The present invention is not limited to embodiments described herein; reference should be had to the appended claims.

### LIST OF REFERENCE NUMERALS

1 Emitter head
2 Inner electrode
3 Outer electrode
4 High-voltage socket
5 Earth connector
6 Inner cooling channel
7 Outer cooling channel
8 Inflow of cooling water
9 Outflow of cooling water
10 Distributor element
11 Chamber
12 Reflector
13 Excimer emitter
14 Irradiation chamber
15 Housing
16 Cladding tube

What is claimed is:

1-6. (canceled)

7. An irradiation device comprising:
a housing;
reflectors arranged on sides of the housing;
an excimer emitter as a UV radiation source, the excimer emitter comprising an inner electrode and an outer electrode;
distributor elements comprising a porous sintered metal, the distributor elements being arranged along the excimer emitter;
a chamber which is configured to act as a buffer volume;
a high-voltage socket;
an earth connection; and
an emitter head comprising holes, the emitter head being provided as a molded body to accommodate the inner electrode and the outer electrode of the excimer emitter, the emitter head being configured,
to form-fittingly guide each of the inner electrode and the outer electrode of the excimer emitter to at least one of the high-voltage socket and to the earth connection, and
to provide a supply of deionized cooling water to an inner cooling channel and to an outer cooling channel via the holes so as to cool the excimer emitter,
wherein,
a nitrogen flushing takes place via the distributor elements and the chamber.

8. The irradiation device as recited in claim 7, wherein the emitter head is made of Teflon.

9. The irradiation device as recited in claim 7, further comprising:
a cylindrical quartz cladding tube;
wherein,
the emitter head further comprises an inflow and an outflow,
the excimer emitter is provided as a hollow quartz cylinder which comprises an outer casing,
the inner cooling channel is arranged in the hollow quartz cylinder,
the outer cooling channel is arranged between the outer casing and the cylindrical quartz cladding tube,
the inner cooling channel is connected to the inflow,
the outer cooling channel is connected to the outflow,
the cooling of the excimer emitter is provided via the inner cooling channel being guided into the outer cooling channel, and
the deionized cooling water has an electrical conductance of <10 μS.

10. The irradiation device as recited in claim 7, further comprising:
an irradiation zone,
wherein, when performing the nitrogen flushing,
the excimer emitter is first flushed with the nitrogen via the buffer volume of the chamber and the distributor elements comprising the porous sintered metal, and
the nitrogen is then fed to inert the irradiation zone by reducing an oxygen concentration in the irradiation zone so as to be <500 ppm.

11. The irradiation device as recited in claim 7, wherein a cross-section of surfaces of the reflectors have a parabolic shape.

12. A method of using the irradiation device as recited in claim 7, the method comprising:
providing the irradiation device as recited in claim 7, and
using the irradiation device to provide a UV cross-linking of at least one of acrylate-based printing inks, acrylate-based coatings, and acrylate-based adhesives.
